(19) United States
(12) Patent Application Publication
(10) Pub. No.: US 2010/0070307 A1
(43) Pub. Date: Mar. 18, 2010

(54) Insurance Verification, Eligibility, Referral and Precertification System and Method

(76) Inventor: Priyamvada Sinvhal-Sharma, Austin, TX (US)

Correspondence Address: Lee & Hayes, PLLC;Margaret Anderson, 601 West Riverside, Suite 1400, Spokane, WA, 99201, US

(21) Appl. No.: 12/404,305

(22) Filed: Mar. 14, 2009

Related U.S. Application Data
(60) Provisional application No. 61/036,884, filed on Mar. 14, 2008.

(51) Int. Cl. G06Q 40/00; G06K 5/00

(52) U.S. Cl. 705/4; 235/380

(57) ABSTRACT

A system and method for providing insurance-related services includes receiving identification data associated with a proposed insured party; storing the identification data in a database; connecting via an internet connection to a source capable of verifying at least a status of the proposed insured party; retrieving information related to the proposed insured party over the internet connection; storing the retrieved information in the database; and converting the information related to the proposed insured party to enable integration of the retrieved information for benefit and billing of services provided to the proposed insured party. The verifying can be via a verification module and benefit module coupled to a processor configured to receive data elements for insurance-related transactions.

### RELATED APPLICATIONS

The non-provisional utility application claims the priority benefit of provisional application: 61/036,884 filed Mar. 14, 2008

### TECHNICAL FIELD

The present application relates generally to systems and method for insurance-related services.

### BACKGROUND

In order for doctors and other medical providers to get reimbursed from the commercial insurance companies as well as from Medicare and Medicaid, healthcare providers have to be sure that the patient they are rendering service to has valid insurance and applicable benefits for the services they are receiving. The current procedures for insurance verification include several methods for verification. One method is to require a telephone call prior to a visit. The patient gives the insurance info to the doctor's office on the phone prior to the appointment. The doctor's office then calls the insurance company to check if the information is valid. This is usually done in advance to the visit to the doctor's office. A second method includes verification by telephone at the time of visit: The patient gives the insurance card to the doctor's office and the office personnel then call the insurance company to check if the information is valid. The insurance card is also scanned for billing purposes and other future references. This is done at the time of the visit to the doctor's office. A third method includes an internet connection prior to a visit. The patient gives the insurance information to the doctor's office on the phone prior to the appointment. The doctor's office then logs on to the relevant insurance company's website and checks to see if the information is valid. This is usually done in advance of the visit to the doctor's office. A fourth method includes an internet connection at the time of the visit. The patient gives the insurance card to the doctor's office and the personal log on to the relevant insurance company's website and check to see if the information is valid. In a fifth method, insurance verification is not done at all. A problem with each of the methods provided is that each includes inefficiencies and risks concerning payment for services rendered. More particularly, many medical practices believe the patient to be an eligible beneficiary of a health plan at the time of service when he or she actually is not. They then focus on post-treatment verification, which makes it more difficult to gather the correct or subsequent information after services have been rendered.

Keeping track of coverage eligibility for all of patients who are enrolled in one type of health care plan or another is difficult. And, the more plans in which a medical practice or other insurance receiver participates, the bigger the problem. Verification is often not pursued due to the time involved in obtaining the information needed. What is needed, therefore, is an efficient and user-friendly method for verifying eligibility of insurance, and performing other insurance-related services.

### SUMMARY

In one aspect, a method for providing insurance-related services includes but is not limited to receiving identification data associated with a proposed insured party; storing the identification data in a database; connecting via an internet connection to a source capable of verifying at least a status of the proposed insured party; retrieving information related to the proposed insured party over the internet connection; storing the retrieved information in the database; and converting the retrieved information related to the proposed insured party to enable integration of the retrieved information for benefit and billing of services provided to the proposed insured party. In addition to the foregoing, other method aspects are described in the claims, drawings, and text forming a part of the present application.

In another aspect, a computer program product includes but is not limited to a signal bearing medium bearing at least one of one or more instructions for receiving identification data associated with a proposed insured party; one or more instructions for storing the identification data in a database; one or more instructions for connecting via an internet connection to a source capable of verifying at least a status of the proposed insured party; one or more instructions retrieving information related to the proposed insured party over the internet connection; one or more instructions for storing the retrieved information in the database; and one or more instructions for converting the retrieved information related to the proposed insured party to enable integration of the retrieved information for benefit and billing of services provided to the proposed insured party In addition to the foregoing, other computer program product aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

In one aspect, a verification system for providing insurance-related services includes but is not limited to a processor; a memory coupled to the processor; a database accessible by the processor, the database configured to store one or more data elements in connection with the insurance-related transaction from or on behalf of an insured party; a verification module coupled to the processor, the verification module configured to verify an identification of the insured party; and a benefit module coupled to the processor, the benefit module configured to determine eligibility for one or more benefits provided by an insurance entity related to the insurance-related transaction. In addition to the foregoing, other verification system aspects are described in the claims, drawings, and text forming a part of the present application.

In addition to the foregoing, various other method, system, and/or computer program product aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a block diagram of an insurance-related system in accordance with an embodiment of the present application showing a verification module;

FIG. 3 is a block diagram of an insurance-related system in accordance with an embodiment of the present application showing a verification module and a benefits eligibility module;

FIG. 4 is a block diagram of an insurance-related system in accordance with an embodiment of the present application showing a verification module, a benefits eligibility module and an approval module;

FIG. 5 is a block diagram of an insurance-related system in accordance with an embodiment of the present application;

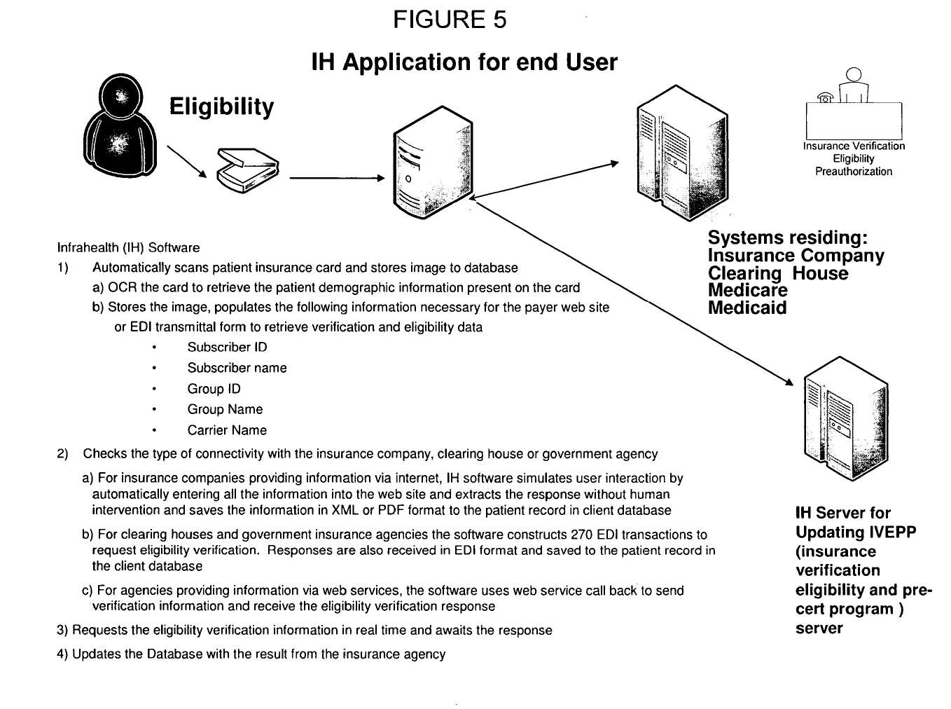

FIG. 6 is a block diagram is a screen print of a graphical user interface in accordance with an embodiment of the present application;

FIG. 7 is a block diagram is a screen print of a graphical user interface in accordance with an embodiment of the present application;

FIG. 8 is a flow diagram of a method in accordance with an embodiment of the present application.

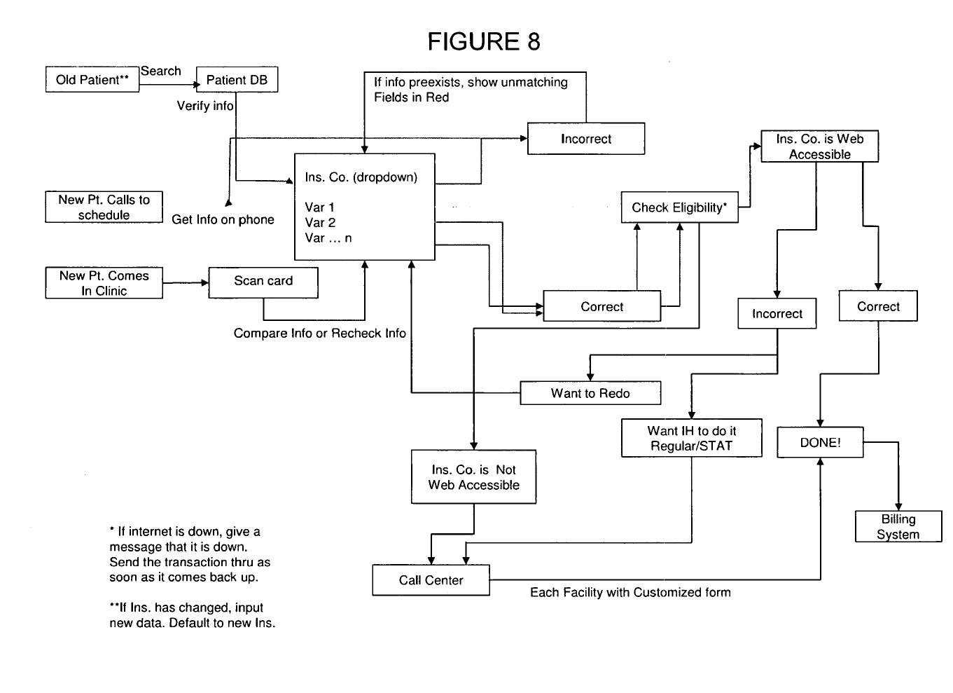

### DETAILED DESCRIPTION OF THE DRAWINGS

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operations described hereinafter can also be implemented in hardware, software, and/or firmware and/or some combination thereof.

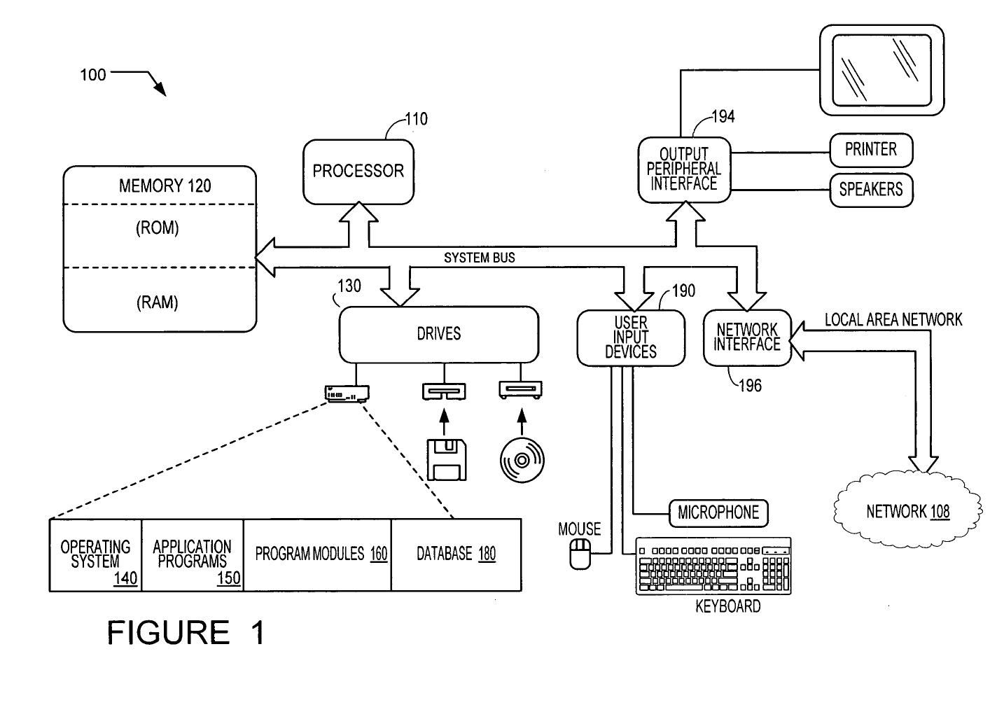

With reference to FIG. 1, depicted is an exemplary computing system for implementing embodiments. FIG. 1 includes a computer 100, including a processor 110, memory 120 and one or more drives 130. The drives 130 and their associated computer storage media, provide storage of computer readable instructions, data structures, program modules and other data for the computer 100. Drives 130 can include an operating system 140, application programs 150, program modules 160, and database 180. Program modules 160 can include a verification module, benefit module, and approval module configured to provide connectivity to network 108 for implementing embodiments herein. Network 108 can include a connection to the internet to enable implementations herein. Alternatively, verification module, benefit module, and approval module can exist as an application program 150 as a stand alone application that can be integrated with other practice management systems using either existing or configured links within computer 100 for integration into practice management systems.

In one embodiment, verification module, benefit module, and approval module operate to retrieve data values and convert them to either XML or PDF format or other appropriate format to allow for parsing of information to automatically populate data fields within a practice management system.

Computer 100 further includes user input devices 190 through which a user may enter commands and data. Input devices can include an electronic digitizer, a microphone, a keyboard and pointing device, commonly referred to as a mouse, trackball or touch pad. Other input devices may include a joystick, game pad, satellite dish, scanner, or the like.

These and other input devices can be connected to processor 110 through a user input interface that is coupled to a system bus, but may be connected by other interface and bus structures, such as a parallel port, or a universal serial bus (USB). Computers such as computer 100 may also include other peripheral output devices such as speakers, which may be connected through an output peripheral interface 194 or the like.

Computer 100 may operate in a networked environment using logical connections to one or more computers, such as a remote computer connected to network interface 196 The remote computer may be a personal computer, a server, a router, a network PC, a peer device or other common network node, and can include many or all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine or vice versa. Note however, that source and destination machines need not be connected by a network 108 or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN, such as the Internet or network 108 It will be appreciated that other means of establishing a communications link between the computers may be used.

According to one embodiment, computer 100 is connected in a networking environment such that the processor 110 and/or program modules 160 can perform with or as a certification system module in accordance with embodiments herein.

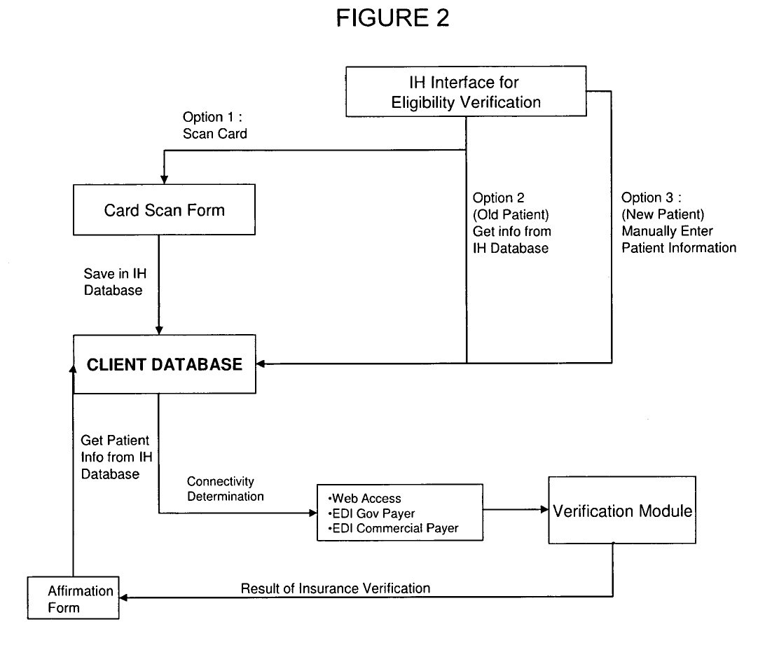

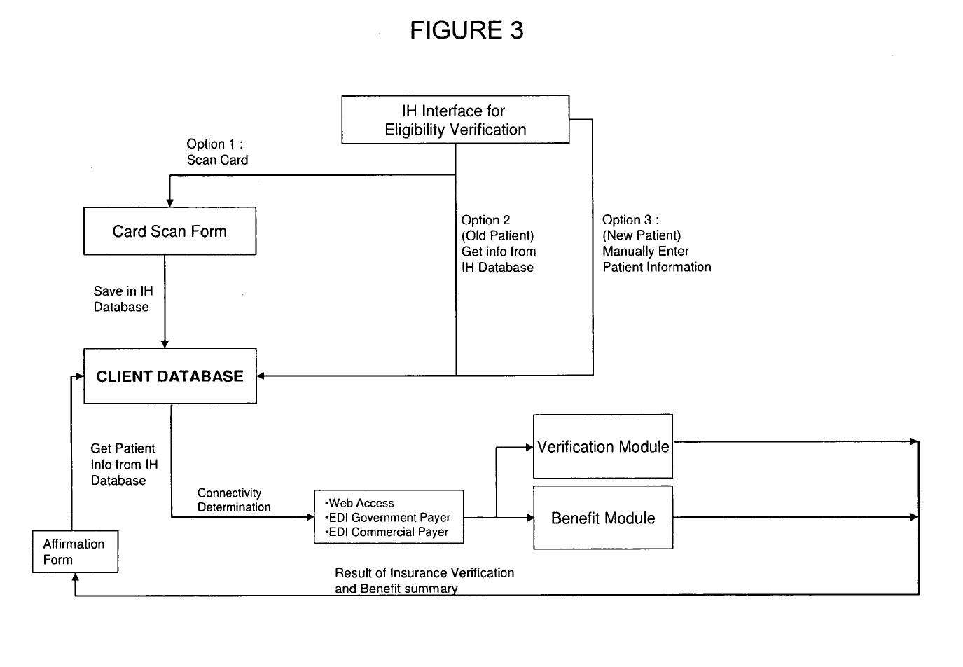

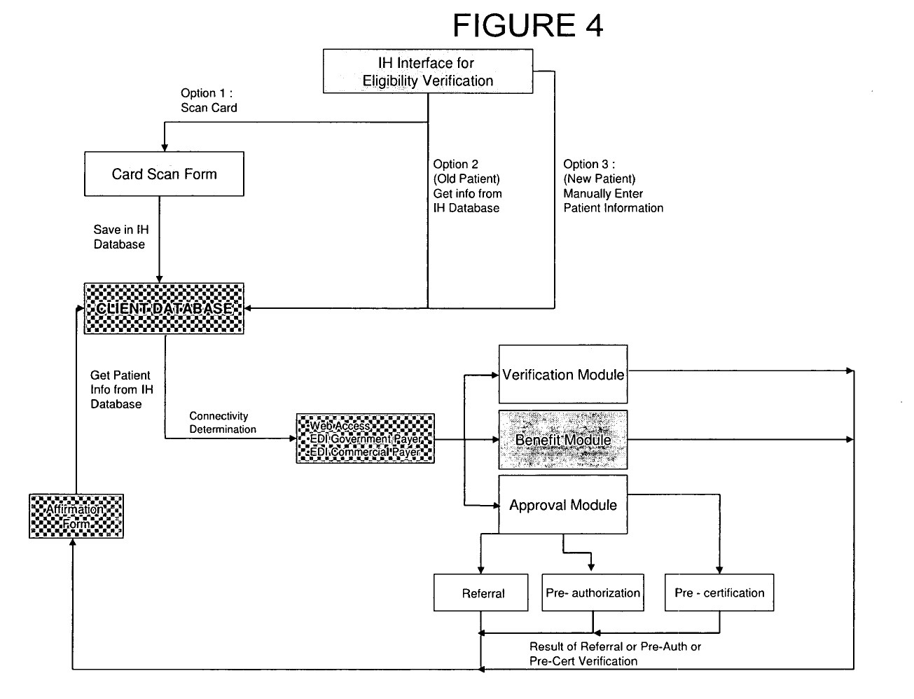

Referring now to FIGS. 2-4, illustrated are exemplary block diagrams of an insurance-related system that can be configured for verifying insurance, determining eligibility, determining precertification, and processing referrals in connection with an insurance-related transaction. Specifically, in one embodiment, as shown in FIGS. 2-4, a method provides for integrating and facilitating single source access for insurance-related services through modules. Modules are provided for managing data across a plurality of databases and proprietary software systems, which can be accessed through a web portal application or via the Internet, thereby eliminating the need for arduous and extensive knowledge of input entry format with respect to database/proprietary system utilization.

In one embodiment, modules and systems provided enable users to proactively electronically determine patient eligibility for services with certain payers, prior to services being performed. Automating the eligibility inquiry, the application ensures prompt patient verification, reduces registration time and prevents payment denials.

In another embodiment, methods are provided to generate inquiries in a real-time mode at the time of admission or registration. Without interrupting or adding to the user's process, benefit information is retrieved from the patient's insurance company via Internet connection, Direct Web access or electronic data interchange (EDI) transmission either directly to the payer or clearinghouse.

All responses can be stored in a database where information may be viewed by the users as many times as they like without being charged for another eligibility request. This will reduce registration time, create labor savings, receive eligibility verification on all patients, reduce denials and lessen errors and omissions.

As shown in each of FIGS. 2-4, in one embodiment, a user interface is provided that collects information on a proposed insured party for purposes of determining insurance benefits, verification and approvals in one or more methods. The user interface can be used to beneficially check insurance status of a patient, prescription benefit, or other purpose. As will be apparent to one of skill in the art with the benefit of the present disclosure, the embodiments herein can be applied to any identification verification need. For example, embodiments can be directed to health care insurance, vision insurance, prescription needs and the like. Other embodiments can be directed to verification of other types of insurance, such as automobile insurance, homeowner's insurance or any type of insurance wherein verification can be performed over an Internet connection and imported. A first method includes scanning an insurance card and determining the information therein for storage to a client database via an optical character recognition (OCR) function. A second method includes determining information by verifying prior patient data. A third method includes manually entiring patient information.

In the first method, the system automatically scans patient insurance card and stores image to database. The system then performs an OCR function on the card to retrieve the patient demographic information present on the card. The system then stores the image, populates the following information necessary for the payer web site or submits EDI transmittal form to retrieve verification and eligibility data. Information typically used in the system includes:

Subscriber ID

Subscriber name

Group ID

Group Name

Carrier Name

The information can be stored in a database, such as client database. Next, the system checks the type of connectivity with the insurance company, clearing house or government agency. For insurance companies providing information via internet, in one embodiment, software simulates user interaction by automatically entering all the information into the web site and extracting the response without human intervention and saves the information in XML or PDF format or other format to the patient record in client database.

For clearing houses and government insurance agencies the software can be configured to construct 270 EDI transactions to request eligibility verification. Responses are also received in EDI format and saved to the patient record in the client database.

For agencies providing information via web services, the software uses web service call back to send verification information and receive the eligibility verification response.

In one embodiment, the system requests the eligibility verification information in real time and awaits the response.

Next, the system updates the client database with the result from the insurance agency or other entity.

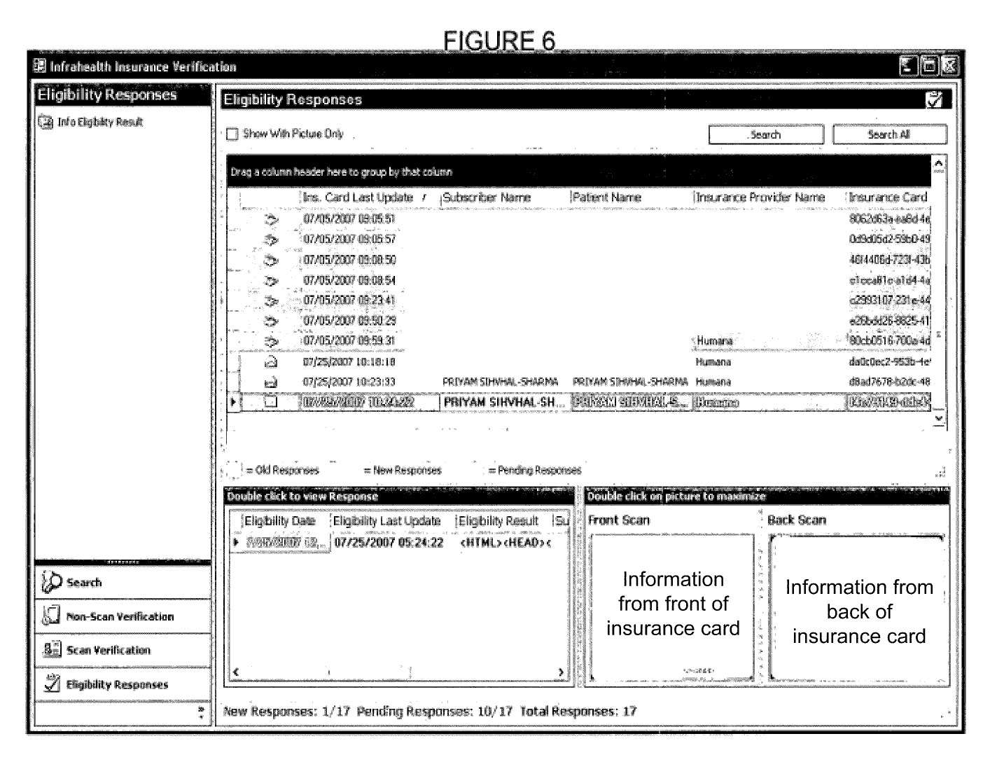

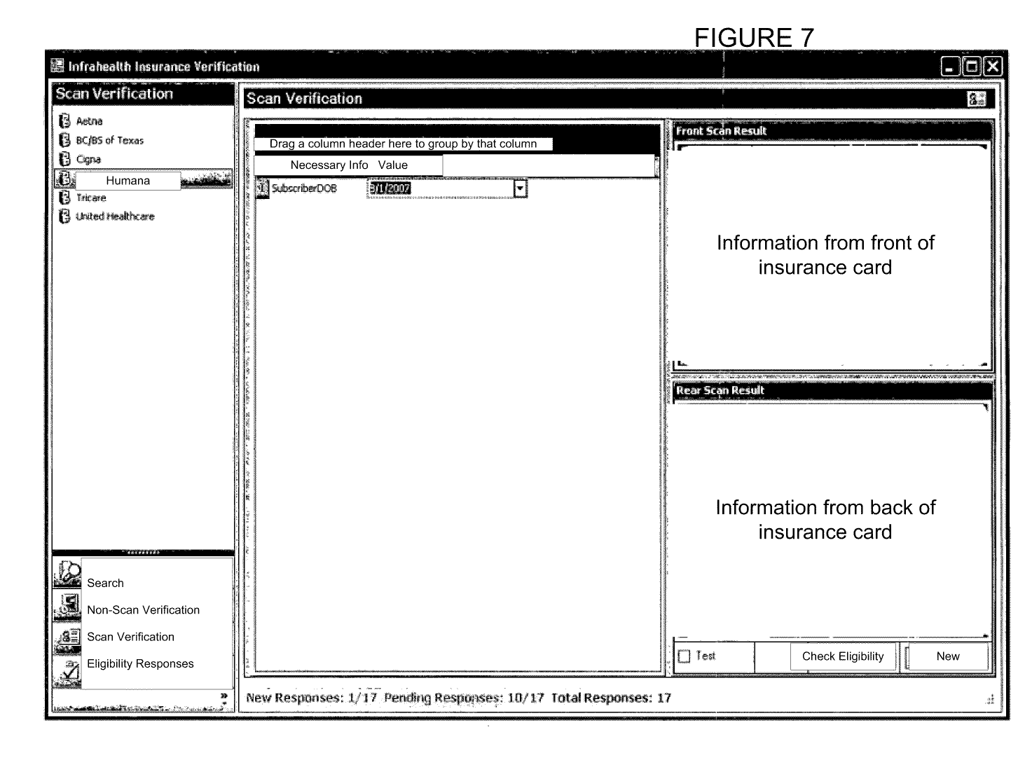

Referring now to FIGS. 6 and 7, screen prints of a graphical user interface are illustrated that are included in an embodiment directed to verifying data regarding a patient's insurance eligibility. By using electronic interfaces, the system automatically connects to a health plan to retrieve information like eligibility dates, co-pay and deductible amounts, excluded services, maximum amount of benefits and other desired information. At the time an appointment is scheduled, a representative can verify insurance over the phone with one click or one can swipe the insurance card when the patient arrives for a visit.

In one embodiment, the system is a stand alone product and is compatible with any billing software. Another embodiment is directed to a terminal based service package for physicians, clinics, hospitals that includes the following services: Patient Eligibility and Benefits; Co payments; Electronic Referrals; and Pre Authorizations.

Those with skill in the computing arts will recognize that the disclosed embodiments have relevance to a wide variety of applications and architectures in addition to those described above. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

We claim:

1. A method for providing insurance-related services, the method comprising:
receiving identification data associated with a proposed insured party;
storing the identification data in a database;
connecting via an internet connection to a source capable of verifying at least a status of the proposed insured party;
retrieving information related to the proposed insured party over the internet connection;
storing the retrieved information in the database; and
converting the retrieved information related to the proposed insured party to enable integration of the retrieved information for benefit and billing of services provided to the proposed insured party.

2. The method of claim 1, wherein the receiving identification data associated with a proposed insured party includes:
receiving the one or more identification data by scanning an insurance card associated with the proposed insured party; and
performing an optical character recognition function on the scanned insurance card.

3. The method of claim 1, wherein the receiving identification data associated with a proposed insured party includes:
receiving the identification data in connection with the insurance-related transaction for storage purposes and/or archiving purposes.

4. The method of claim 1, wherein the receiving identification data associated with a proposed insured party includes:
receiving the identification data from the proposed insured party as part of a service for a health-care provider.

5. The method of claim 4, wherein the receiving the identification data from the proposed insured party as part of a service for a health-care provider includes:
receiving the identification data as a fee-based transaction.

6. The method of claim 1, wherein the storing the identification data in a database includes:
storing the identification data in a database maintained by a third party and/or maintained by a health care provider.

7. The method of claim 1, wherein the connecting via an internet connection to a source capable of verifying at least a status of the proposed insured party includes:
connecting to one or more of a health insurance entity and/or a government entity.

8. A computer program product comprising:
a signal bearing medium bearing;
one or more instructions for receiving identification data associated with a proposed insured party;
one or more instructions for storing the identification data in a database;
one or more instructions for connecting via an internet connection to a source capable of verifying at least a status of the proposed insured party; and
one or more instructions retrieving information related to the proposed insured party over the internet connection;
one or more instructions for storing the retrieved information in the database; and
one or more instructions for converting the retrieved information related to the proposed insured party to enable integration of the retrieved information for benefit and billing of services provided to the proposed insured party

9. The computer program product of claim 8 wherein the signal bearing medium comprises:
a recordable medium.

10. The computer program product of claim 8 wherein the signal bearing medium comprises:
a transmission medium.

11. An insurance verification system for verifying one or more insured parties in connection with an insurance-related transaction, the insurance verification system comprising:
a processor;
a memory coupled to the processor;
a database accessible by the processor, the database configured to store one or more data elements in connection with the insurance-related transaction from or on behalf of an insured party;
a verification module coupled to the processor, the verification module configured to verify an identification of the insured party; and
a benefit module coupled to the processor, the benefit module configured to determine eligibility for one or more benefits provided by an insurance entity related to the insurance-related transaction;
an approval module coupled to the processor, the approval module configured to perform one or more of a referral verification, a pre-authorization of services and/or a pre-certification.
